(19) United States
(12) Patent Application Publication
(10) Pub. No.: US 2026/0063012 A1
(43) Pub. Date: Mar. 5, 2026

(54) ADJUSTABLE SPOOL

(71) Applicant: Schlumberger Technology Corporation, Sugar Land, TX (US)

(72) Inventors: Brandon Ermis, Sugar Land, TX (US); Wilmer Palomino, Sugar Land, TX (US); Christina Nguyen, Sugar Land, TX (US)

(21) Appl. No.: 19/309,900

(22) Filed: Aug. 26, 2025

Related U.S. Application Data
(60) Provisional application No. 63/689,283, filed on Aug. 30, 2024.

(51) Int. Cl. E21B 33/038; F16L 23/028

(52) U.S. Cl. CPC E21B 33/038; F16L 23/0283

(57) ABSTRACT

A device includes a spacer pipe, a box including first and second ends and an internal passage, and a pin including an annular outer shoulder. The first end of the box is connected to the spacer pipe, and the second end of the box is configured to receive a first end of the pin in an adjustable configuration. The device also includes a lock down ring configured to secure the first end of the pin received in the second end of the box.

### CROSS-REFERENCE TO RELATED APPLICATION

This application claims the benefit of U.S. Provisional Patent Application No. 63/689,283, filed August 30, 2024, which is incorporated by reference herein in its entirety.

### BACKGROUND

Offshore drilling operations may include the use of floating platforms for the exploitation of subterranean petroleum and natural gas deposits. A riser connects the subsea well with the platform to protect the fluid integrity of the well and to provide a fluid conduit to and from the wellbore.

Among other things, the offshore drilling system may include pressure control equipment and various drill thru components. A rigid spool may be used to connect one or more of these pieces together.

### SUMMARY

According to one or more embodiments of the present disclosure, a device includes: a spacer pipe; a box including: a first end; a second end; and an internal passage; a pin including an annular outer shoulder, wherein the first end of the box is connected to the spacer pipe, and wherein the second end of the box is configured to receive a first end of the pin in an adjustable configuration; and a lock down ring configured to secure the first end of the pin received in the second end of the box.

According to one or more embodiments of the present disclosure, a device includes: a box including: a female end portion; an outer diameter at the female end portion; an inner diameter at the female end portion; and an internal passage corresponding with the inner diameter; a pin including: a male end portion; a first outer diameter at the male end portion; and a second outer diameter distanced away from the first outer diameter, wherein the second outer diameter is larger than the first outer diameter, wherein the first outer diameter at the male end portion of the pin is smaller than the inner diameter at the female end portion of the box, wherein the female end portion of the box is configured to receive the male end portion of the pin along the internal passage in an adjustable configuration, and a lock down ring configured to secure the male end portion of the pin received in the female end portion of the box.

According to one or more embodiments of the present disclosure, a method includes: inserting a male end portion of a pin into a female end portion of a box in an adjustable configuration, wherein the box includes an internal passage, wherein the pin comprises an annular outer should distanced away from the male end portion, and wherein the adjustable configuration includes a configuration in which the female end portion of the box abuts against the annular outer shoulder of the pin, creating a space within the internal passage of the box that is delineated by the male end portion of the pin; and securing the male end portion of the pin within the internal passage of the box with a lock down ring.

However, many modifications are possible without materially departing from the teachings of this disclosure. Accordingly, such modifications are intended to be included within the scope of this disclosure as defined in the claims.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIG. 1 shows an isometric view of an adjustable spool, according to one or more embodiments of the present disclosure; and

FIG. 2 shows a cross-sectional view of an adjustable spool, according to one or more embodiments of the present disclosure.

### DETAILED DESCRIPTION

In the following description, numerous details are set forth to provide an understanding of some embodiments of the present disclosure. However, it will be understood by those of ordinary skill in the art that the system and/or methodology may be practiced without these details and that numerous variations or modifications from the described embodiments may be possible.

In the specification and appended claims, the terms “connect,” “connection,” “connected,” “in connection with,” and “connecting,” are used to mean “in direct connection with,” in connection with via one or more elements.” The terms “couple,” “coupled,” “coupled with,” “coupled together,” and “coupling” are used to mean “directly coupled together,” or “coupled together via one or more elements.” The term “set” is used to mean setting “one element” or “more than one element.” As used herein, the terms “up” and “down,” “upper” and “lower,” “upwardly” and “downwardly,” “upstream” and “downstream,” “uphole” and “downhole,” “above” and “below,” “top” and “bottom,” and other like terms indicating relative positions above or below a given point or element are used in this description to more clearly describe some embodiments of the disclosure. Commonly, these terms relate to a reference point at the surface from which drilling operations are initiated as being the top point and the total depth being the lowest point, wherein the well (e.g., wellbore, borehole) is vertical, horizontal, or slanted relative to the surface.

In general, embodiments of the present disclosure relate to offshore drilling systems. More specifically, embodiments of the present disclosure relate to an adjustable spool for use in offshore drilling systems.

Conventionally, an offshore drilling system may include a rigid spool that connects pressure control equipment and drill thru components together. For example, a rigid spool may be used to connect a blowout preventer “BOP” stack assembly with a subsea wellhead in the offshore drilling system. The rigid spool is usually a fixed pipe that is physically fit on the drilling system equipment connected thereto. Moreover, the rigid spool is usually a “field fit” weld. That is, extra length is initially added to the rigid spool with the expectation that the rigid spool will need to be adjusted in the field. Once an installer in the field determines the correct dimensions for the rigid spool within the offshore drilling assembly, an end of the rigid spool is cut to fit, welded on site, and fixed to the desired drilling system equipment or drill thru component.

From time to time, the drilling system equipment (e.g., pressure containing equipment) or drill thru component (e.g., riser connector, annular, other connector, etc.) that the rigid spool is fixed to will need to be replaced due to unplanned component damage or failure, Special Periodic Survey (SPS) activity, or during a new build operation. Such replacement operations are particularly problematic and time consuming when a rigid spool is fixed to the drilling system equipment or drill thru component in need of replacement.

As an example, the SPS involves required structural investigations and inspections on a periodic basis during which the offshore drilling assembly is torn down and drilling system equipment and/or drill thru components are replaced with fleet spare components. These SPS activities can cause issues with machining and fabrication stack up tolerances. When this happens, a new spool having dimensions corresponding to the newly replaced equipment and components needs to be fabricated and welded in place before operations can continue. In addition to this, the newly replaced offshore drilling assembly may need to be shipped onshore for testing, and then shipped back to the offshore drilling rig before operations can continue.

Advantageously, one or more embodiments of the present disclosure provides an adjustable spool that allows drilling system equipment and/or drill thru components to be replaced at any time during operations without the need to fabricate a new spool.

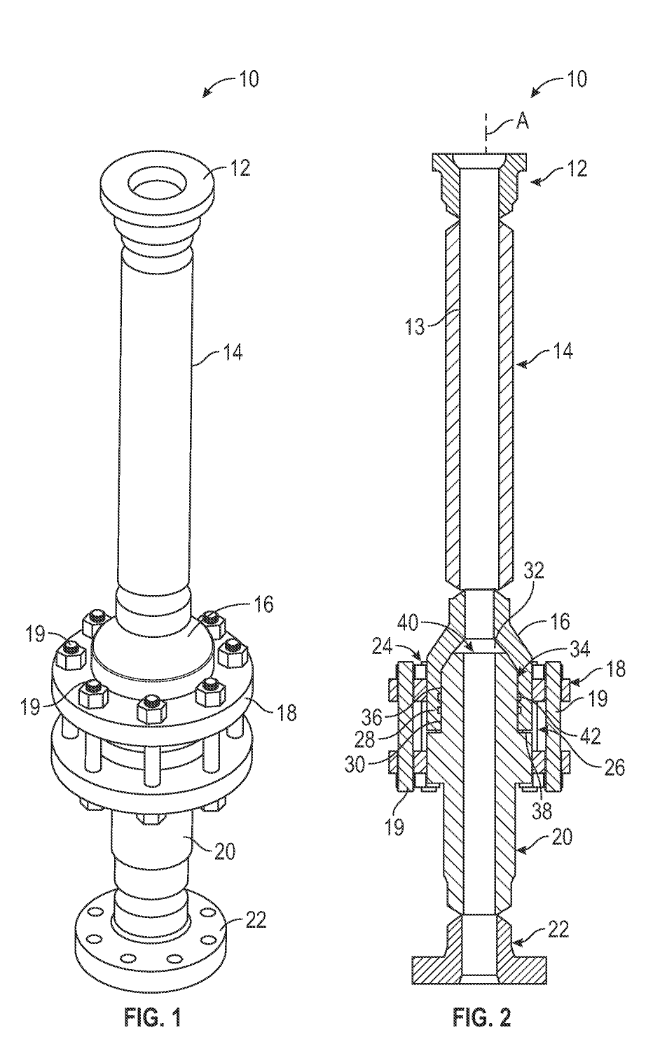

Referring now to FIG. 1, an isometric view of an adjustable spool 10 is shown according to one or more embodiments of the present disclosure. As shown in FIG. 1, the adjustable spool 10 may include a weld neck hub 12 connected to a spacer pipe 14. According to one or more embodiments of the present disclosure, the adjustable spool 10 may be connected to a drilling system component, such as pressure containing equipment or a drill thru component, via the weld neck hub 12. According to one or more embodiments of the present disclosure, the spacer pipe 14 is rigid tubing, or at least semi-rigid tubing, thereby imparting structural integrity to the adjustable spool 10.

Still referring to FIG. 1, the adjustable spool 10 also includes a box 16, a pin 20, and a lock down ring 18, according to one or more embodiments of the present disclosure. As shown in FIG. 1, a first end of the box 16 is connected to the spacer pipe 14. As also shown in FIG. 1, and as further described below, a second end of the box 16 receives a first end of the pin 20 in an adjustable configuration. According to one or more embodiments of the present disclosure, the lock down ring 18 is configured to secure the first end of the pin 20 received in the second end of the box 16. As shown in FIG. 1, the lock down ring 18 is configured to secure the first end of the pin 20 received in the second end of the box 16 with a plurality of bolts 19, for example.

As also shown in FIG. 1, the adjustable spool 10 according to one or more embodiments of the present disclosure includes a weld neck flange 22 that is connected to a second end of the pin 20. According to one or more embodiments of the present disclosure, the weld neck flange 22 is configured to connect to a drilling system component or a drill thru component, for example. Advantageously, an existing rigid spool of an offshore drilling system may simply be removed and replaced with a new adjustable spool 10, according to one or more embodiments of the present disclosure.

Referring now to FIG. 2, a cross-sectional view of an adjustable spool 10 according to one or more embodiments of the present disclosure is shown. As more clearly shown in FIG. 2, the adjustable spool 10 according to one or more embodiments of the present disclosure may include a thru bore 13 along a longitudinal axis A of the adjustable spool 10. In the offshore drilling system according to one or more embodiments of the present disclosure, a choke and/or kill line (not shown) is the fluid pathway with the adjustable spool 10 being a component in the overall larger BOP stack. In this way, the choke and/or kill line may also be in fluid communication with any drilling system component or a drill thru component that the adjustable spool 10 is connected to, for example, according to one or more embodiments of the present disclosure.

As previously described, FIG. 1 shows that a second end of the box 16 receives a first end of the pin 20 in an adjustable configuration 24. The adjustable configuration 24 is more clearly shown in the cross-sectional view of FIG. 2. For example, FIG. 2 shows that the box 16 includes a female end portion 26, an outer diameter 28 at the female end portion 26, an inner diameter 30 at the female end portion 26, and an internal passage 32 corresponding with the inner diameter 30, according to one or more embodiments of the present disclosure. The internal passage 32, the outer diameter 28 at the female end portion 26, and the thru bore 13 have different diameters, but are all coincident, sharing the same center point, according to one or more embodiments of the present disclosure. FIG. 2 also shows that pin 20 includes a male end portion 34, a first outer diameter 36 at the male end portion 34, and a second outer diameter 38 (i.e., an annular outer shoulder) distanced away from the first outer diameter 36. According to one or more embodiments of the present disclosure, the second outer diameter 38 of the pin 20 is larger than the first outer diameter 36 of the pin 20. Moreover, the first outer diameter 36 at the male end portion 34 of the pin 20 is smaller than the inner diameter 30 at the female end portion 26 of the box 16, according to one or more embodiments of the present disclosure.

As such, according to one or more embodiments of the present disclosure, the female end portion 26 of the box 16 is configured to receive the male end portion 34 of the pin 20 along the internal passage 32 in the adjustable configuration 24. According to one or more embodiments of the present disclosure, the adjustable configuration 24 includes a configuration in which the outer diameter 28 at the female end portion 26 of the box 16 abuts against the second outer diameter 38 (i.e., annular outer shoulder) of the pin 20, creating a space 40 within the internal passage 32 of the box 16 that is delineated by the male end portion 34 of the pin 20. Advantageously, the space 40 contributes to a “floating effect” that allows the adjustable spool 10 to adjust across different dimensions and tolerances when replacing drilling system equipment and/or drill thru components in a way that cannot be achieved by a fixed rigid spool. That is, due to the adjustable configuration 24 of the adjustable spool 10, drilling system equipment and/or drill thru components within the offshore drilling system may be replaced at any time during operations without the need to fabricate a new spool.

As further shown in FIG. 2, at least one seal 42 may be disposed around the first outer diameter 36 at the male end portion 34 of the pin 20, according to one or more embodiments of the present disclosure. The at least one seal 42 may be an annular seal or an O-ring seal, for example. As previously described, the first outer diameter 36 at the male end portion 34 of the pin 20 is smaller than an inner diameter 30 at the female end portion 26 of the box 16, according to one or more embodiments of the present disclosure. As such, the at least one seal 42 is positioned to seal an interface between the first outer diameter 36 at the male end portion 34 of the pin 20 and the inner diameter 30 at the female end portion 26 of the box 16, making this interface fluid-tight and/or air-tight during drilling operations, for example, according to one or more embodiments of the present disclosure.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and/or within less than 0.01% of the stated amount. As another example, in certain embodiments, the terms “generally parallel” and “substantially parallel” or “generally perpendicular” and “substantially perpendicular” refer to a value, amount, or characteristic that departs from exactly parallel or perpendicular, respectively, by less than or equal to 15 degrees, 10 degrees, 5 degrees, 3 degrees, 1 degree, or 0.1 degree.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A device, comprising:
a spacer pipe;
a box comprising: a first end; a second end; and an internal passage;
a pin comprising an annular outer shoulder,
wherein the first end of the box is connected to the spacer pipe, and
wherein the second end of the box is configured to receive a first end of the pin in an adjustable configuration; and
a lock down ring configured to secure the first end of the pin received in the second end of the box.

2. The device of claim 1, wherein the adjustable configuration comprises a configuration in which the second end of the box abuts against the annular outer shoulder of the pin, creating a space within the internal passage of the box that is delineated by the first end of the pin.

3. The device of claim 1, wherein the spacer pipe is rigid.

4. The device of claim 1, further comprising a weld neck hub connected to the spacer pipe, wherein the weld neck hub is configured to connect to a drilling system component.

5. The device of claim 1, further comprising: a weld neck flange connected to a second end of the pin.

6. The device of claim 5, wherein the weld neck flange is configured to connect to a drilling system component.

7. The device of claim 1, wherein the lock down ring is configured to secure the first end of the pin received in the second end of the box with a plurality of bolts.

8. A device, comprising:
a box comprising:
a female end portion;
an outer diameter at the female end portion;
an inner diameter at the female end portion; and
an internal passage corresponding with the inner diameter;
a pin comprising:
a male end portion;
a first outer diameter at the male end portion; and
a second outer diameter distanced away from the first outer diameter,
wherein the second outer diameter is larger than the first outer diameter,
wherein the first outer diameter at the male end portion of the pin is smaller than the inner diameter at the female end portion of the box,
wherein the female end portion of the box is configured to receive the male end portion of the pin along the internal passage in an adjustable configuration; and
a lock down ring configured to secure the male end portion of the pin received in the female end portion of the box.

9. The device of claim 8, wherein the adjustable configuration comprises a configuration in which the outer diameter at the female end portion of the box abuts against the second outer diameter of the pin, creating a space within the internal passage of the box that is delineated by the male end portion of the pin.

10. The device of claim 8, further comprising: a spacer pipe connected to an end of the box opposite the female end portion.

11. The device of claim 10, further comprising a weld neck hub connected to the spacer pipe, wherein the weld neck hub is configured to connect to a drilling system component.

12. The device of claim 8, further comprising: a weld neck flange connected to a second end of the pin opposite the male end portion.

13. The device of claim 12, wherein the weld neck flange is configured to connect to a drilling system component.

14. The device of claim 8, wherein the lock down ring is configured to secure the male end portion of the pin received in the female end portion of the box with a plurality of bolts.

15. The device of claim 8, further comprising at least one seal disposed around the first outer diameter at the male end portion of the pin.

16. A method, comprising:
inserting a male end portion of a pin into a female end portion of a box in an adjustable configuration,
wherein the box comprises an internal passage,
wherein the pin comprises an annular outer shoulder distanced away from the male end portion, and
wherein the adjustable configuration comprises a configuration in which the female end portion of the box abuts against the annular outer shoulder of the pin, creating a space within the internal passage of the box that is delineated by the male end portion of the pin; and
securing the male end portion of the pin within the internal passage of the box with a lock down ring.

17. The method of claim 16,
wherein a spacer pipe is connected to an end of the box opposite the female end portion,
wherein a weld neck hub is connected to the spacer pipe, and
wherein a weld neck flange is connected to a second end of the pin opposite the male end portion.

18. The method of claim 17, further comprising connecting the weld neck hub to a first drilling system component.

19. The method of claim 18, further comprising connecting the weld neck flange to a second drilling system component.
